(19) United States
(12) Patent Application Publication
(10) Pub. No.: US 2024/0146419 A1
(43) Pub. Date: May 2, 2024

(54) OPTICAL TRANSMITTER, OPTICAL RECEIVER, AND OPERATING METHODS THEREOF

(71) Applicant: ELECTRONICS AND TELECOMMUNICATIONS RESEARCH INSTITUTE, Daejeon (KR)

(72) Inventors: Sunghyun BAE, Gyeonggi-do (KR); Sang Rok MOON, Sejong-si (KR); Hun Sik KANG, Daejeon (KR)

(21) Appl. No.: 18/111,016

(22) Filed: Feb. 17, 2023

(30) Foreign Application Priority Data
Nov. 1, 2022 (KR) 10-2022-0143825

(51) Int. Cl. H04B 10/50; H04B 10/61

(52) U.S. Cl. CPC H04B 10/503; H04B 10/61

(57) ABSTRACT

An optical transmitter, an optical receiver, a method of operating the optical transmitter, and a method of operating the optical receiver are provided. The optical transmitter includes a light source configured to output laser light, an intensity modulator configured to provide a pulse signal with a predetermined period using the laser light, an in-phase and quadrature (I/Q) modulator configured to generate a coherent modulated signal applying an I/Q signal to the pulse signal with the predetermined period, and a polarization controller configured to delay one of polarization components forming the coherent modulated signal.

### CROSS-REFERENCE TO RELATED APPLICATION(S)

This application claims the benefit of Korean Patent Application No. 10-2022-0143825 filed on Nov. 1, 2022, in the Korean Intellectual Property Office, the entire disclosure of which is incorporated herein by reference for all purposes.

### BACKGROUND

### 1. Field of the Invention

One or more embodiments relate to an optical transmitter and an optical receiver that may economically eliminate communication outage due to polarization rotation and dispersion to reduce a complexity of a coherent optical communication system, even though a single polarization coherent receiver is used, and methods of operating the optical transmitter and the optical receiver.

### 2. Description of Related Art

A coherent optical communication system is widely used in long-distance optical communication systems. Since an optical transmitter of the coherent optical communication system utilizes both real number and imaginary number domains and an optical receiver relies on shot noise, the coherent optical communication system is advantageous in obtaining a higher signal-to-noise ratio (SNR) than systems utilizing an intensity modulation transmitter or direct receiver. In addition, the coherent optical communication system may directly compensate for linear signal distortion of an electric field, such as color dispersion, and thus, it is easy to increase a transmission distance.

In a conventional coherent optical communication system, a polarization division multiplexed signal is transmitted and an optical receiver with polarization diversity must be used to receive the polarization division multiplexed signal. Even when a single polarization signal is transmitted, since polarization rotates inside an optical fiber, an optical receiver with polarization diversity must be used to prevent communication interruption.

That is, an optical receiver used in the conventional coherent optical communication system should include a polarization beam splitter (PBS) for polarization diversity, but it is not easy to manufacture an optical receiver by integrating such polarization elements. Therefore, it is not easy to lower the price and reduce the size of the optical receiver, so despite excellent performance, such a coherent optical communication system is not preferred in a short-distance optical communication system.

### SUMMARY

Embodiments provide a structure of an optical transmitter and an optical receiver that may reduce the complexity of an optical communication system that transmits a coherent signal. According to an aspect, there is provided an optical transmitter including a light source configured to output laser light, an intensity modulator configured to provide a pulse signal with a predetermined period using the laser light, an in-phase and quadrature (I/Q) modulator configured to generate a coherent modulated signal by applying an I/Q signal to the pulse signal with the predetermined period, and a polarization controller configured to delay one of polarization components forming the coherent modulated signal.

The coherent modulated signal in which one of the polarization components is delayed may be used to restore the I/Q signal by an optical receiver including a polarizing plate configured to pass a single polarization component and using a local oscillator (LO) signal polarized in a same direction as a direction of the polarizing plate.

The polarization controller may include a polarization splitter configured to split the coherent modulated signal into an x polarization component and a y polarization component, a polarization delayer configured to delay one of the x polarization component and the y polarization component into which the coherent modulated signal is split by a predetermined time, and a polarization combiner configured to combine a polarization component delayed by the predetermined time with the other polarization component.

The polarization delayer may be configured to delay one of the x polarization component and the y polarization component by a time corresponding to half of a symbol.

According to an aspect, there is provided an optical receiver including a polarizing plate configured to pass a single polarization component from an optical signal transmitted through an optical transmitter, a single polarization coherent receiver configured to detect a specific polarization component from the transmitted optical signal using an LO signal polarized in a same direction as a direction of the polarizing plate, and a digital signal processor configured to restore an I/Q signal from the detected polarization component, wherein the optical signal transmitted through the optical transmitter is a coherent modulated signal in which one of polarization components is delayed and combined.

The coherent modulated signal may be a signal in which one of the polarization components is delayed by a time corresponding to half of a symbol and combined.

According to an aspect, there is provided a method of operating an optical transmitter including outputting laser light through a light source, providing a pulse signal with a predetermined period using the laser light through an intensity modulator, generating a coherent modulated signal by applying an I/Q signal to the pulse signal with the predetermined period through an I/Q modulator, and delaying one of polarization components forming the coherent modulated signal through a polarization controller.

The coherent modulated signal in which one of the polarization components is delayed may be used to restore the I/Q signal by an optical receiver comprising a polarizing plate configured to pass a single polarization component and using a local oscillator (LO) signal polarized in a same direction as a direction of the polarizing plate.

The delaying of one of the polarization components may include splitting the coherent modulated signal into an x polarization component and a y polarization component through a polarization splitter, delaying one of the x polarization component and the y polarization component into which the coherent modulated signal is split by a predetermined time through a polarization delayer, and combining a polarization component delayed by the predetermined time with the other polarization component through a polarization combiner.

The delaying of one of the x polarization component and the y polarization component by the predetermined time may include delaying one of the x polarization component and the y polarization component by a time corresponding to half of a symbol.

According to an aspect, there is provided a method of operating an optical receiver including passing a single polarization component from an optical signal transmitted through an optical transmitter through a polarizing plate, detecting a polarization component from the transmitted optical signal using an LO signal polarized in a same direction as a direction of the polarizing plate through a single polarization coherent receiver, and restoring an I/Q signal from the detected polarization component through a digital signal processor, wherein the optical signal transmitted through the optical transmitter is a coherent modulated signal in which one of polarization components is delayed and combined.

The coherent modulated signal may be a signal in which the one of the polarization components is delayed by a time corresponding to half of a symbol and combined.

Additional aspects of embodiments will be set forth in part in the description which follows and, in part, will be apparent from the description, or may be learned by practice of the disclosure.

According to embodiments, a coherent modulated signal may be detected without communication outage using a single polarization coherent receiver that does not utilize polarization diversity.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a structure of an optical transmitter of a coherent optical communication system according to an embodiment;

FIG. 2 is a flowchart illustrating a method of operating an optical transmitter, according to an embodiment;

FIG. 3 is a diagram illustrating a structure of an optical receiver of a coherent optical communication system according to an embodiment;

FIG. 4 is a flowchart illustrating a method of operating an optical receiver, according to an embodiment; and

FIG. 5 is a diagram illustrating transmission using a quadrature phase shift keying (QPSK) method according to an embodiment.

### DETAILED DESCRIPTION

The following detailed structural or functional description is provided as an example only and various alterations and modifications may be made to the examples. Here, examples are not construed as limited to the disclosure and should be understood to include all changes, equivalents, and replacements within the idea and the technical scope of the disclosure.

Terms, such as “first”, “second”, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/including” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, examples will be described in detail with reference to the accompanying drawings. When describing the embodiments with reference to the accompanying drawings, like reference numerals refer to like elements and any repeated description related thereto will be omitted.

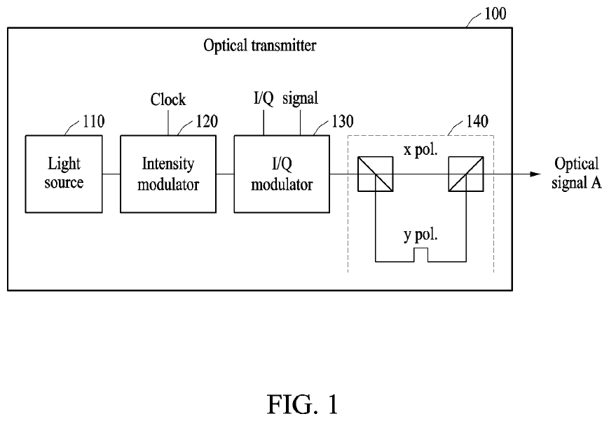

FIG. 1 is a diagram illustrating a structure of an optical transmitter of a coherent optical communication system according to an embodiment.

Referring to FIG. 1, an optical transmitter 100 may include a light source 110, an intensity modulator 120, an in-phase and quadrature (I/Q) modulator 130, and a polarization controller 140. The light source 110 may output laser light, and the intensity modulator 120 may generate a pulse signal with a predetermined period using the laser light output from the light source 110. Here, the intensity modulator 120 may generate a pulse signal having various types of waveforms such as sine waves, square waves, ramp waves, and the like by modulating the intensity of the laser light using a clock signal provided from outside.

The I/Q modulator 130 may generate a coherent modulated signal using the pulse signal with the predetermined period generated through the intensity modulator 120. Here, the I/Q modulator 130 may generate the coherent modulated signal by dividing and modulating an in-phase component I and a quadrature component Q of the pulse signal with the predetermined period, using the I/Q signal provided from the outside.

The polarization controller 140 may output an optical signal A to be transmitted to an optical receiver by delaying one of polarization components forming the coherent modulated signal generated through the I/Q modulator 130. Here, the optical receiver may include a single polarization coherent receiver.

In this way, the optical signal A output by delaying one of the polarization components may be used to restore the I/Q signal by the optical receiver including a polarizing plate that passes a single polarization component and using a local oscillator (LO) signal polarized in a same direction as a direction of the polarizing plate.

That is, the present disclosure may provide a structure of the optical transmitter 100 that may economically eliminate communication interruption due to polarization rotation and dispersion even though only one I/Q modulator 130 is used, unlike the related art using two I/Q modulators.

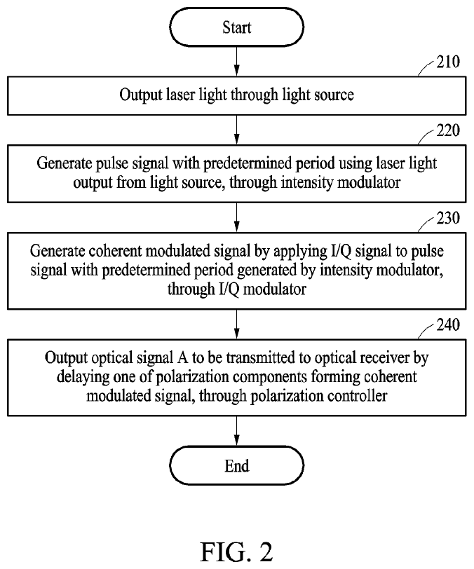

FIG. 2 is a flowchart illustrating a method of operating an optical transmitter, according to an embodiment.

In operation 210, the optical transmitter 100 may output laser light through the light source 110.

In operation 220, the optical transmitter 100 may generate the pulse signal with the predetermined period using the laser light output from the light source 110, through the intensity modulator 120. Here, the intensity modulator 120 may generate a pulse signal having various types of waveforms such as sine waves, square waves, ramp waves, and the like by modulating the intensity of the laser light using the clock signal provided from the outside.

In operation 230, the optical transmitter 100 may generate the coherent modulated signal using the pulse signal with the predetermined period generated by the intensity modulator 120, through the I/Q modulator 130. Here, the I/Q modulator 130 may generate the coherent modulated signal by dividing and modulating the in-phase component I and the quadrature component Q of the pulse signal with the predetermined period using the I/Q signal provided from the outside.

In operation 240, the optical transmitter 100 may output the optical signal A to be transmitted to the optical receiver by delaying one of the polarization components forming the coherent modulated signal, through the polarization controller 140. More specifically, the optical transmitter 100 may split the coherent modulated signal into an x polarization component and a y polarization component, through the polarization splitter of the polarization controller 140.

Then, the optical transmitter 100 may delay one of the x polarization component and the y polarization component into which the coherent modulated signal is split by a predetermined time, through the polarization delayer of the polarization controller 140. Here, the optical transmitter 100 may delay one of the polarization components by a time corresponding to an n+½ symbol through the polarization delayer. Although the description of FIG. 1 provides a configuration in which the optical transmitter 100 delays they polarization component by the predetermined time, the above description is only an example and not limited thereto.

Finally, the optical transmitter 100 may output the optical signal A to be transmitted to the optical receiver by combining a delayed polarization component by the predetermined time and the other polarization component, through the polarization combiner of the polarization controller 140.

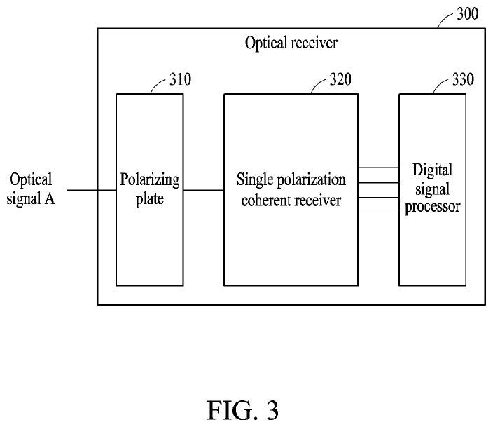

FIG. 3 is a diagram illustrating a structure of an optical receiver of a coherent optical communication system according to an embodiment.

Referring to FIG. 3, an optical receiver 300 may include a polarizing plate 310, a single polarization coherent receiver 320, and a digital signal processor 330. The polarizing plate 310 may pass a single polarization signal from the optical signal A transmitted through the optical transmitter 100.

Here, the optical signal A transmitted through the optical transmitter 100 may be a coherent modulated signal in which one of polarization components is delayed by a predetermined time and combined. For example, the coherent modulated signal, which is the optical signal A transmitted through the optical transmitter 100, may be a signal in which one of the polarization components is delayed by a time corresponding to half of a symbol and combined.

The single polarization coherent receiver 320 may detect a specific polarization component from the optical signal A transmitted through the optical transmitter 100, using the LO signal polarized in the same direction as the direction of the polarizing plate 310.

The digital signal processor 330 may restore the I/Q signal from the specific polarization component detected through the single polarization coherent receiver 320.

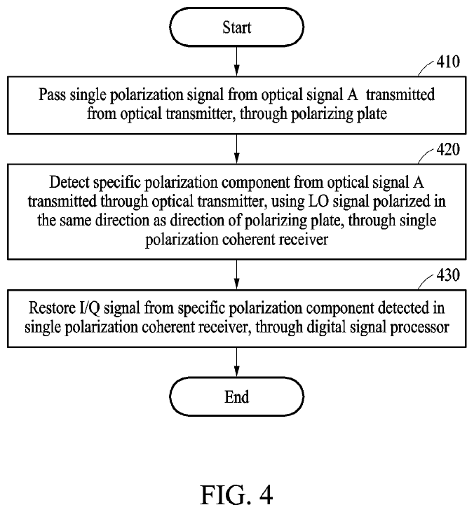

FIG. 4 is a flowchart illustrating a method of operating an optical receiver, according to an embodiment.

In operation 410, the optical receiver 300 may pass the single polarization signal from the optical signal A transmitted from the optical transmitter 100, through the polarizing plate 310. Here, the optical signal A transmitted through the optical transmitter 100 may be the coherent modulated signal in which one of the polarization components is delayed by the predetermined time and combined. For example, the coherent modulated signal, which is the optical signal A transmitted through the optical transmitter 100, may be a signal in which one of the polarization components is delayed by the time corresponding to half of the symbol and combined.

In operation 420, the optical receiver 300 may detect the specific polarization component from the optical signal A transmitted through the optical transmitter 100, using the LO signal polarized in the same direction as the direction of the polarizing plate 310, through the single polarization coherent receiver 320.

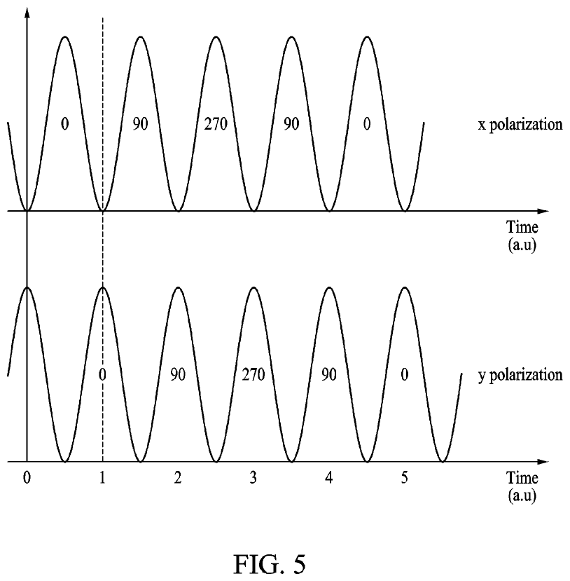

For example, FIG. 5 is a diagram illustrating using a quadrature phase shift keying (QPSK) method according to an embodiment. Referring to FIG. 5, the laser light in which the intensity is modulated with the sine wave may be modulated by the QPSK method by the I/Q modulator. It is assumed that the coherent modulated signal modulated through the I/Q modulator is sequentially modulated in a time domain with {0 degree (°), 90°, 270°, 90°, 0°, . . . }, as shown in FIG. 5. The coherent modulated signal may be branched into the x polarization component and the y polarization component by the polarization splitter and the y polarization component may be delayed by half of the symbol compared to the x polarization component.

In the single polarization coherent receiver 320 of the optical receiver 300, when only the x polarization component is detected, a 0° component transmitted from t=“0” to “1” may be detected and when only the y polarization component is detected by polarization rotation and the like, the 0° component transmitted from t=“0.5” to “1.5” may be detected. In the single polarization coherent receiver 320 of the optical receiver 300, when the x polarization component and the y polarization component are detected by 50%, the 0° component transmitted from t=“0” to “1” and the 0° component transmitted from t=“0.5” to “1.5” may be detected separately.

Finally, in operation 430, the optical receiver 300 may restore the I/Q signal from the specific polarization component detected in the single polarization coherent receiver 320, through the digital signal processor 330. For example, the digital signal processor 330 may be a feed forward equalizer (FFE) or a decision feedback equalizer (DFE) but the above description is only an example and not limited thereto.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The examples described herein may be implemented using hardware components, software components and/or combinations thereof. A processing device may be implemented using one or more of general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

What is claimed is:

1. An optical transmitter comprising:
a light source configured to output laser light;
an intensity modulator configured to provide a pulse signal with a predetermined period using the laser light;
an in-phase and quadrature (I/Q) modulator configured to generate a coherent modulated signal by applying an I/Q signal to the pulse signal with the predetermined period; and
a polarization controller configured to delay one of polarization components forming the coherent modulated signal.

2. The optical transmitter of claim 1, wherein the coherent modulated signal in which one of the polarization components is delayed is used to restore the I/Q signal by an optical receiver comprising a polarizing plate configured to pass a single polarization component and using a local oscillator (LO) signal polarized in a same direction as a direction of the polarizing plate.

3. The optical transmitter of claim 1, wherein the polarization controller comprises:
a polarization splitter configured to split the coherent modulated signal into an x polarization component and a y polarization component;
a polarization delayer configured to delay one of the x polarization component and the y polarization component into which the coherent modulated signal is split by a predetermined time; and
a polarization combiner configured to combine a polarization component delayed by the predetermined time with the other polarization component.

4. The optical transmitter of claim 3, wherein the polarization delayer is configured to delay one of the x polarization component and the y polarization component by a time corresponding to half of a symbol.

5. An optical receiver comprising:
a polarizing plate configured to pass a single polarization component from an optical signal transmitted through an optical transmitter;
a single polarization coherent receiver configured to detect a specific polarization component from the transmitted optical signal using a local oscillator (LO) signal polarized in a same direction as a direction of the polarizing plate; and
a digital signal processor configured to restore an in-phase and quadrature (I/Q) signal from the detected polarization component,
wherein the optical signal transmitted through the optical transmitter is a coherent modulated signal in which one of polarization components is delayed and combined.

6. The optical receiver of claim 5, wherein the coherent modulated signal is a signal in which one of the polarization components is delayed by a time corresponding to half of a symbol and combined.

7. A method of operating an optical transmitter, the method comprising:
outputting laser light through a light source;
providing a pulse signal with a predetermined period using the laser light through an intensity modulator;
generating a coherent modulated signal by applying an in-phase and quadrature (I/Q) signal to the pulse signal with the predetermined period through an I/Q modulator; and
delaying one of polarization components forming the coherent modulated signal through a polarization controller.

8. The method of claim 7, wherein the coherent modulated signal in which one of the polarization components is delayed is used to restore the I/Q signal by an optical receiver comprising a polarizing plate configured to pass a single polarization component and using a local oscillator (LO) signal polarized in a same direction as a direction of the polarizing plate.

9. The method of claim 7, wherein the delaying of one of the polarization components comprises:
splitting the coherent modulated signal into an x polarization component and a y polarization component through a polarization splitter;
delaying one of the x polarization component and the y polarization component into which the coherent modulated signal is split by a predetermined time through a polarization delayer; and
combining a polarization component delayed by the predetermined time with the other polarization component through a polarization combiner.

10. The method of claim 9, wherein the delaying of one of the x polarization component and the y polarization component by the predetermined time comprises delaying one of the x polarization component and the y polarization component by a time corresponding to half of a symbol.
